(19) United States
(12) Patent Application Publication
(10) Pub. No.: US 2026/0285078 A1
(43) Pub. Date: Sep. 24, 2026

(54) SECURITY THREAD WITH A MAGNETIC ELEMENT

(71) Applicant: MAGNETIC ID LTD, Crewe (GB)

(72) Inventors: Ian GIBB, Crewe (GB); Ian Robert ELVER, Crewe (GB); Stewart HEFFERMAN, Crewe (GB)

(21) Appl. No.: 18/874,056

(22) PCT Filed: Jun. 23, 2023
(86) PCT No.: PCT/GB2023/051646

§ 371 Date: Dec. 11, 2024

(30) Foreign Application Priority Data
Jun. 23, 2022 (GB) 2209209.2

(51) Int. Cl. B42D 25/355; B41M 3/14; B41M 7/00; B42D 25/369; C09D 11/037; C09D 11/101

(52) U.S. Cl. CPC B42D 25/355; B41M 3/14; B41M 7/0081; B42D 25/369; C09D 11/037; C09D 11/101

(57) ABSTRACT

A method of making a magnetic security feature. A layer of ink comprising a first set of particles and a second set of particles in suspension within the liquid ink is printed onto a substrate. The particles are magnetically anisotropic and acicular. A permanent magnet is moved along the printed ink layer, followed by an electromagnet which is turned on and off selectively as it is moved along the printed ink layer. The electromagnet has a magnetic field strength which is higher than the coercivity of the particles of the second set but lower than the particle of the first set. The resulting magnetic security feature has a magnetic pattern across it, which has subtle differences between areas over which the electromagnet was turned off versus those over which it was turned on that are harder for counterfeiters to notice and/or copy.

### TECHNICAL FIELD OF THE INVENTION

The present invention relates to magnetic security features, and particularly, but not exclusively, to security threads with magnetic elements.

### BACKGROUND TO THE INVENTION

It is of interest to counterfeiters to duplicate certain highly valuable documents, such as bank notes, identity cards, transportation tickets, credit or debit cards, tax banderols and product labels. In an attempt to prevent such duplication and so prevent the production of counterfeits and fraud, such documents can have security features built into them. Typical security features include security threads, windows, fibres, planchettes, foils, decals, holograms and watermarks. A further security feature is that the documents can be printed using security inks with pigments that give rise to a range of different physical characteristics (e.g. thermochromic, photochromic, infra-red absorbing, optically variable, magnetic thin film interference, interference coated as well as ultra-violet absorbing).

A security thread is typically a thin ribbon or filament (plastic or metal) that is thread through, embedded into or applied directly to the document. Security threads often carry security elements to enable public and/or machine-readable authentication. An example of this is banknotes with security threads, wherein the threads often have text or numbers to denote denomination and can be authenticated visually and/or by more covert methods. More covert features have become particularly useful as counterfeits have become increasingly more sophisticated and replicated other security features, since the presence of such features isn't as obvious. One such covert feature is the incorporation of magnetic components.

These magnetic components can be read by a machine, the correct reading validating the document. Although used within the industry, magnetic security features do have disadvantages. One of the key disadvantages is that they lack complexity, meaning they can be relatively easy for counterfeiters to copy if they are aware of their existence. This also means a limited amount of information can be represented in one magnetic security feature.

Embodiments of the present invention seek to ameliorate these or other disadvantages and provide an improved magnetic security feature.

### SUMMARY OF THE INVENTION

According to a first aspect of the present invention there is provided a method of creating a magnetic security feature, the method comprising the steps of:
(a) Printing an ink onto a substrate, the ink comprising a first set of particles and a second set of particles, wherein the particles are magnetically anisotropic and the coercivity of the particles of the first set is higher than the coercivity of the particles of the second set;
(b) Exposing at least part of the printed ink layer to a first magnet with a magnetic field strength greater than the coercivity of the particles of the first set and aligned in a first direction, to orientate the particles of the first set and the second set in a first direction;
(c) Exposing one or more sections of the printed ink layer to a second magnet with a magnetic field strength greater than the coercivity of the particles of the second set but less than the coercivity of the particles of the first set and aligned in a second direction, to orientate the particles of the second set in the sections of the security thread in a second direction, the second direction being different from the first direction; and then
(d) Curing the printed ink layer, locking the particles of the first and second sets in their orientations.

Having two sets of particles which can be orientated in different directions means the resulting magnetic security feature is far more complex and so harder to counterfeit, resulting in a more secure document. In addition, the difference between the magnetic readings of areas in which all the sets of particles are orientated in the first direction and areas where the first set are in the first direction and the second set are in the second direction can be less pronounced, and therefore harder for counterfeiters to notice and/or copy, resulting in a more secure document.

The particles of the first and/or second set may be non-spherical. The particles of the first and/or second set may be acicular.

The magnetic security feature may be a security thread with a magnetic element. The method may comprise the additional step of:
(e) exposing one or more sections of the printed ink layer to a third magnet with a magnetic field strength greater than the coercivity of the particles of the first set and aligned in a third direction, to orientate the particles of the first set and the second set in the third direction, the third direction being different to the first direction.

The third magnet may be an electromagnet. The third direction may be the same as the second direction.

The first and/or the third magnets may be operable to have two different write currents, a first write current with a magnetic field strength greater than the coercivity of the particles of the first set and a second write current with a magnetic field strength greater than the coercivity of the particles of the second set but less than the coercivity of the particles of the first set. The first and/or third magnets may vary between the two different write currents in use.

The printed ink layer may form a line. The printed ink layer may form a contiguous layer. The printed ink layer may form a non-contiguous layer. The printed ink layer may be one or more units of ink. Each unit may be defined by at least one of the sets of particles within it being orientated in a different direction to and/or being physically separated from the adjacent units. One or more units of ink may be discrete. The units of ink may be discrete. The units of ink may be a mixture of discrete and non-discrete units. One or more of the units may be part-discrete, wherein it is physically separated from an adjacent unit on one side but contiguous with the adjacent unit on the other side. The units of ink may be arranged in the line. The length of each unit of ink may be along part of the length of the line. The units of ink may be arranged consecutively in the line. The units of ink may be of equal width. The units of ink may be equal length. The units of ink may vary in length. The entirety of each unit of ink may form part of the one or more sections and/or the at least part, or the rest of the printed ink layer. The printed ink layer may be approximately 5 μm in thickness. The printed ink layer may be less than 5 μm in thickness.

Discrete units of ink are more distinct, leading the printed layer of ink comprising them being easier to read. The units of ink varying in length allows the size of each unit to convey information further increasing the complexity of the magnetic security feature and allowing the same sized feature to convey additional information.

The physical separations may be approximately rectangular. The physical separations may be equal size. The physical separations may vary in size. Each physical separation may be the same size across the width of the printed ink layer.

The units of ink may be formed of a first set of units and a second set of units. The first set of units and second set of units may be of equal width. The first set of units may be of a first length, and the second set of units may be a second length, the first length being different from the second length. The first set of units and second set of units may vary in length. The first set of particles within the first and second sets of units may be orientated in the first direction. The second set of particles within the second set of units may be orientated in the second direction. The second set of particles within the first set of units may be orientated in a different direction. The second set of particles within the first set of units may be orientated in the first direction.

The units of ink may be formed of the first set of units, the second set of units, and a third set of units. The orientation of the first and second set of particles in the third set of units may be random.

The units of ink may be formed of the first set of units, the second set of units, the third set of units, a fourth set of units, and a fifth set of units. The orientation of the first set of particles in the fourth set of units may be in the third direction, and the orientation of the second set of particles in the fourth set of units may be in the third direction. The orientation of the first set of particles in the fourth set of units may be in the third direction, and the orientation of the second set of particles in the fourth set of units may be in the second direction.

The units of ink may be formed of the first set of units, the second set of units, the third set of units, the fourth set of units, the fifth set of units, and a sixth set of units. The orientation of the first set of particles in the sixth set of units may be random, and the orientation of the second set of particles in the sixth set of units may be in the second direction. Each set of particles may be held in suspension within the liquid ink prior to curing.

Each unit may be rectangular. The width of each unit may extend across the width of the printed image layer. The width of each unit may be parallel with the width of the printed image layer. The width of each unit may be at an angle to the width of the printed image layer.

The first magnet may be exposed to the entirety of the printed ink layer. Alternatively, the first magnet may be exposed to one or more parts of the printed ink layer. The one or more parts may be non-contiguous.

The second magnet may be sized and positioned to be exposed at one point in time to an area of the printed ink layer with a minimum length which is the same length or smaller than the shortest length of unit of ink.

A printer may print the printed ink layer onto the substrate.

A minimum length of a feature which the printer can print may be the same length or a smaller length than the shortest length unit of ink. A minimum length of a feature which the printer can print may be the same length or a smaller length than the shortest length well. The second magnet may be sized and positioned to be exposed at one point in time to an area of the printed ink layer with a minimum length which is the same length or smaller than the combined length of the shortest length unit of ink and any adjacent space or spaces.

When the first magnet is exposed to one or more parts of the printed ink, the sections to which the second magnet is exposed may form the one or more parts. The sections may be a subset of the one or more parts. The third magnet may be exposed to the rest of the printed ink. The third magnet may be exposed to a subset of the rest of the printed ink. Additionally or alternatively, the third magnet may be exposed to a subset of the one or more parts. The sections may be non-contiguous.

The first magnet may be a permanent magnet. The first magnet may be an electromagnet. The second magnet may be an electromagnet. The second magnet may be a permanent magnet. The or each electromagnet may be a magnetic write head.

The substrate may comprise plastic. The substrate may primarily comprise plastic. The plastic may be polyester. The substrate may be formed from one or more layers. One or more of the layers may be adhesive. One or more of the layers may be demetallised. One or more of the layers may be printed. The substrate may be thinner than 20 μm.

The ink may be printed on a surface of the substrate. The surface may comprise a series of wells into which the ink is printed. The series of wells may be formed by etching into the substrate. The series of wells may be the voids in a repeating or random pattern formed on the substrate. The ink may be a magnetic slurry. The series of wells may be created by any of the following: gravure printing, chemical etching, or laser ablation. Each unit may be within a well. Each well may contain one or more units of ink. Each well may define the size of the unit, or combined sized of the units, within it. A series of wells allows the separations to be more distinct, resulting in the printed ink layer being easier to read.

The first and second directions may be within the same plane as the printed ink layer. The first, second and third directions may be within the same plane as the printed ink layer. The second direction may be between 20 and 90 degrees to the first direction. The second direction may be between 30 and 90 degrees to the first direction. The second direction may be between 20 and 60 degrees to the first direction. The second direction may be between 30 and 60 degrees to the first direction. The first direction may be at an angle to a longitudinal axis of the printed ink layer. The angle may be an acute angle. The first direction may be between 20 to 90 degrees to the longitudinal axis of the printed ink layer. The first direction may be between 30 to 90 degrees to the longitudinal axis of the printed ink layer. The first direction may be between 20 to 60 degrees to the longitudinal axis of the printed ink layer. The first direction may be between 30 to 60 degrees to the longitudinal axis of the printed ink layer. The second direction may be in line with the longitudinal axis of the printed ink layer. The second direction may be in line with the length of each unit of the printed ink layer. The third direction may be between 20 and 90 degrees to the first direction. The second direction may be between 20 and 60 degrees to the first direction.

The first direction may be in line with the longitudinal axis of the printed ink layer. Alternatively, the third direction may be in line with the longitudinal axis of the printed ink layer. The first direction may be ±60 degrees to the longitudinal axis of the printed ink layer. The third direction may be +60 degrees to the longitudinal axis of the printed ink layer. The third direction may be ±20 to 90 degrees to the first direction. The second direction may be +20 to 90 degrees to the first direction. The second direction may be +20 to 90 degrees to the third direction.

The printer may comprise a print head. The print head may be orthogonal to the second direction, printing the layer of ink along the second direction.

The second direction being in line with the length of each unit of the printed ink layer means the second set of particles within units forming part of the or each section may be orientated without orientating particles in other part of the printed ink layer.

The ink may be light curable. The ink may be ultra-violet light curable. The method may comprise exposing the printed ink layer to an ultra-violet light source to cure the ink.

Step (c) may be subsequent to step (b). Step (c) being subsequent prevents step (b) overwriting the work of step (c) when the same areas of the printed ink layer are exposed to both magnets. Step (e) may be subsequent to step (b). Step (e) may be prior to step (c). Alternatively, step (e) may be prior to step (b). In this case, step (b) may be prior to step (c).

The magnetic security feature may move relative to the printer, first magnet, second magnet, third magnet and/or ultra-violet light source. In the relative movement, the printer may print along a length of the substrate to print the layer of ink. The printer may print along a length of the substrate from a first end to a second end. In the relative movement, the first magnet, third magnet, and/or second magnet may be adjacent to the printed ink layer to magnetise the particles. The first magnet may magnetise subsequently to the printer. The second magnet may magnetise subsequently to the first magnet. The third magnet may magnetise subsequently to the first magnet, but prior to the second magnet. Alternatively the first magnet may magnetise subsequently to the third magnet, but prior to the second magnet. In the relative movement, the ultra-violet light source may be adjacent to the printed ink layer to cure the ink, subsequently to the first, third and/or second magnets. The first magnet, the third magnet, the second magnet and/or the ultra-violet light source may magnetise/cure along the length of the substrate. The first magnet, the third magnet, the second magnet and/or the ultra-violet light may magnetise/cure along the length of the substrate from a first end to a second end. The first magnet may begin magnetising along the length of the substrate while the printer is partway along printing the length. The second magnet may begin magnetising along the length of the substrate while the first magnet is partway through magnetising along the length. The second magnet may begin magnetising along the length of the substrate while the printer is partway along printing the length. The ultra-violet light source may begin curing along the length of the substrate while the second magnet is partway through magnetising along the length. The ultra-violet light source may begin curing along the length of the substrate while the first magnet is partway through magnetising along the length. The ultra-violet light source may begin curing along the length of the substrate while the printer is partway through printing along the length. The third magnet may begin magnetising while the first magnet is partway through magnetising along the length. Alternatively, the first magnet may begin magnetising while the third magnet is partway through magnetising along the length. The third magnet may begin magnetising along the length of the substrate while the printer is partway along printing the length. The second magnet may begin magnetising along the length of the substrate while the third magnet is partway through magnetising along the length.

As the first magnet, the third magnet, and/or second magnet magnetise along the length from the first end to the second end, they may magnetise areas of the printed ink they are opposite at each point in time. As the first magnet, the third magnet, and/or second magnet magnetise along the length from the first end to the second end, they may magnetise areas of the printed ink they are underneath at each point in time.

As the printer prints along the length from the first end to the second end, it may print ink onto the areas it faces at each point in time.

As the ultra-violet light source cures along the length from the first end to the second end, it may cure areas of ink it is faces at each point in time.

For the relative movement, it may instead be the printer, first magnet, second magnet, third magnet and/or ultra violet light source which move relative to the magnetic security feature.

The printer, first magnet, second magnet, third magnet, and/or ultra-violet light source may all form part of a magnetic security feature manufacturing machine. The substrate may be rolled to move relative to the printer, first magnet, second magnet, third magnet, and/or ultra violet light source.

The printer, first magnet, second magnet, third magnet, and/or ultra-violet light source may be at least as wide as the printed ink layer. The printer, first magnet, second magnet, third magnet, and/or ultra violet light source may extend across the entire width of the printed ink layer.

The printer, first magnet, second magnet, third magnet and ultra-violet light source may be arranged in a line within the magnetic security feature manufacturing machine, from the entrance to the exit. The first magnet, third magnet and/or second magnet may be positioned at a distance from each other so as to prevent their magnetic field from interfering with each other and/or with the respective areas of the magnetic security feature they are each passing over at a point in time.

The printer, first magnet, second magnet, third magnet, and/or ultra-violet light source may face the surface of the substrate when printing/magnetising/curing. The printer may be in contact with the surface of the substrate when printing. The ultra-violet light source may be positioned to direct light at the printed ink layer when curing. The first, third and/or second magnet may be underneath the substrate when magnetising. The ultra-violet light may be underneath the substrate when curing. The substrate may be transparent.

The or each electromagnet may be turned on to expose the one or more sections of the printed ink layer. The or each electromagnet may be turned on when adjacent to the or each section to expose the or each section. A current through the or each electromagnet may be modified. The current through the or each electromagnet may be varying. The current may vary in magnitude. The current may vary in direction. The current may vary in discrete steps. The current may be a continuous variable. The current through the or each electromagnet may vary between a forward current and a reverse current. The or each electromagnet may be turned off when adjacent other parts of the printed ink layer. The or each electromagnet may be turned on when it is adjacent the one or more sections and turned off when it is adjacent other parts of the printed ink layer. The or each electromagnet may be pulsed on and off. The or each electromagnet may be pulsed on and off in a pattern. The or each electromagnet may be pulsed on and off in a repeating pattern. The or each electromagnet may be pulsed on and off in a non-repeating pattern.

According to a second aspect of the present invention there is provided a magnetic security feature comprising a substrate and a printed ink layer, wherein:
(a) the printed ink layer is on the substrate;
(b) the ink comprises a first set of particles and a second set of particles, the particles being magnetically anisotropic and the coercivity of the particles of the first set being higher than the coercivity of the particles of the second set;
(c) Within at least part of the printed ink layer, the first set of particles are orientated in a first direction;
(d) Within one or more sections of the printed ink layer, the second set of particles are orientated in a second direction, wherein the second direction is different from the first direction; and
(e) The printed ink layer is cured.

Having two sets of particles which can be orientated in different directions means the resulting magnetic security feature is far more complex and so harder to counterfeit, resulting in a more secure document. In addition, the difference between the magnetic readings of areas in which all the sets of particles are orientated in the first direction and areas where the first set are in the first direction and the second set are in the second direction can be less pronounced, and therefore harder for counterfeiters to notice and/or copy, resulting in a more secure document.

The second aspect of the present invention may comprise any or all of the optional features of the first aspect, as desired or appropriate.

Within the at least part of the printed ink layer and outside the one or more sections, the second set of particles may be orientated in the first direction.

According to a third aspect of the present invention, there is provided a document comprising a magnetic security feature according to the second aspect of the present invention.

The document may be any of the following: a bank note, an identity card, a transportation ticket, a credit or debit card, a tax banderol or a product label.

The third aspect of the present invention may comprise any or all of the optional features of the first and/or second aspect, as desired or appropriate.

According to a fourth aspect of the present invention there is provided a method of creating a magnetic security feature, the method comprising the steps of:
(a) Printing an ink onto a substrate to form a non-contiguous layer of printed ink, the ink comprising a set of particles which are magnetically anisotropic;
(b) Exposing at least part of the non-contiguous layer of printed ink to a first magnet with a magnetic field strength greater than the coercivity of the particles and aligned in a first direction, to orientate the particles in a first direction; then
(c) Exposing one or more sections of the non-contiguous layer of printed ink to a second magnet with a magnetic field strength greater than the coercivity of the particles and aligned in a section direction, to orientate the particles in a second direction, the second direction being different from the first direction; and then
(d) Curing the printed ink, locking the particles in their orientations.

The fourth aspect of the present invention may comprise any or all of the optional features of the first aspect, as desired or appropriate.

The set of particles may be a first set of particles, and the ink may additionally comprise a second set of particles which are magnetically anisotropic. The coercivity of the particles of the second set may be lower than the coercivity of the particles of the first set.

According to a fifth aspect of the present invention there is provided a magnetic security feature comprising a printed ink layer and a substrate, wherein:
(a) The printed ink layer is non-contiguous;
(b) The ink comprises a set of magnetic particles which are magnetically anisotropic;
(c) Within at least part of the non-contiguous printed ink layer, the magnetic particles are orientated in a first direction;
(d) Within one or more sections of the non-contiguous printed ink layer, the magnetic particles are orientated in a second direction which is different from the first direction; and
(e) The ink is cured.

The fifth aspect of the present invention may comprise any or all of the optional features of the first, second, third and/or fourth aspect, as desired or appropriate.

According to a sixth aspect of the present invention, there is provided a document comprising a magnetic security feature according to the fifth aspect of the present invention.

The sixth aspect of the present invention may comprise any or all of the optional features of the first, second, third, fourth and/or fifth aspect, as desired or appropriate.

### DETAILED DESCRIPTION OF THE INVENTION

In order that the invention may be more clearly understood one or more embodiments thereof will now be described, by way of example only, with reference to the accompanying drawings, of which:

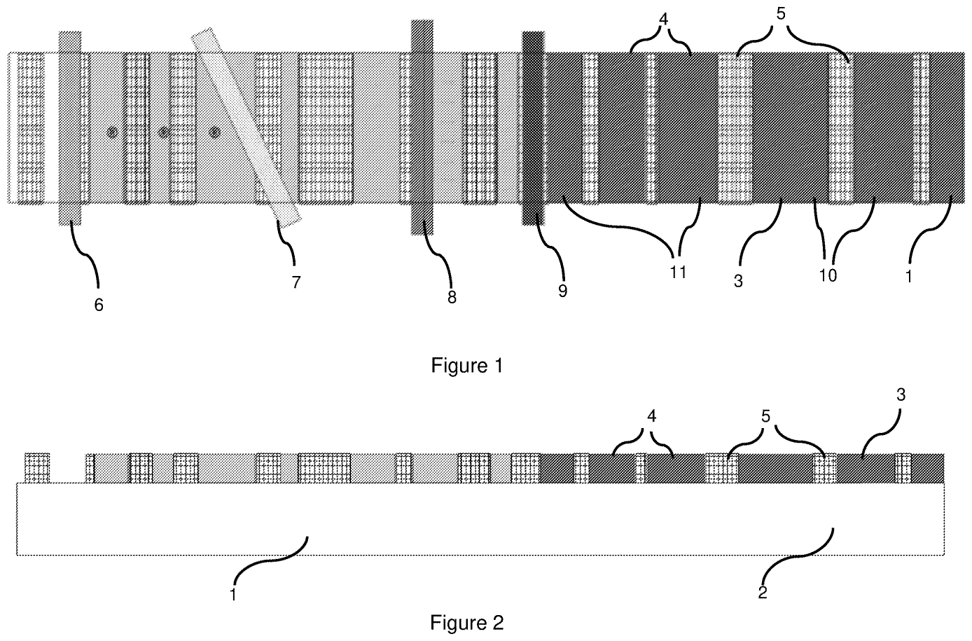

FIG. 1 shows a plan view of the creation of a set of magnetic security features;

FIG. 2 shows a side view of the creation of the set of magnetic security features of FIG. 1;

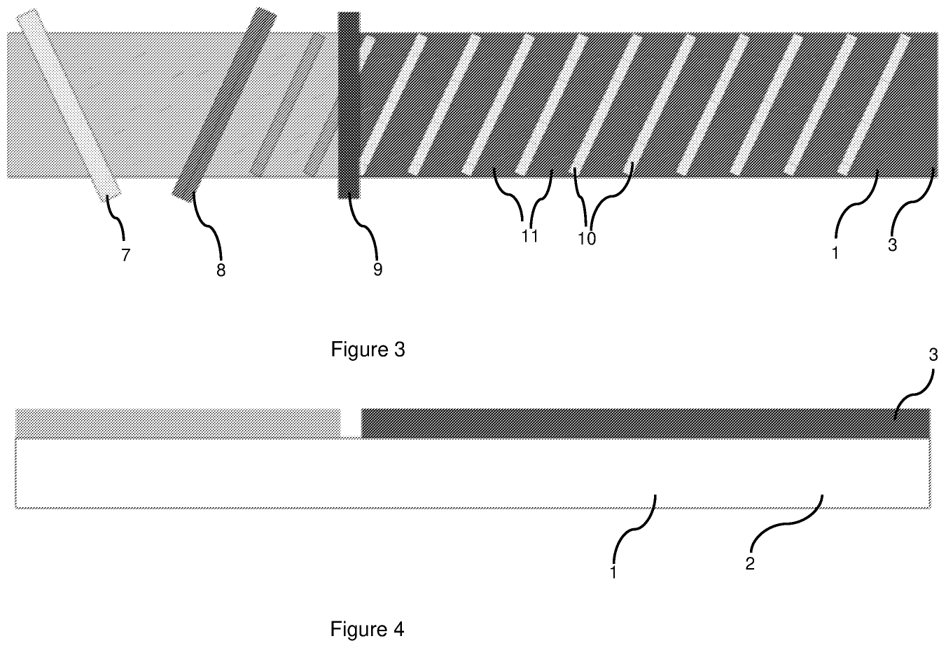

FIG. 3 shows a plan view of the creation of a set of magnetic security features;

FIG. 4 shows a side view of the creation of the magnetic security feature of FIG. 3;

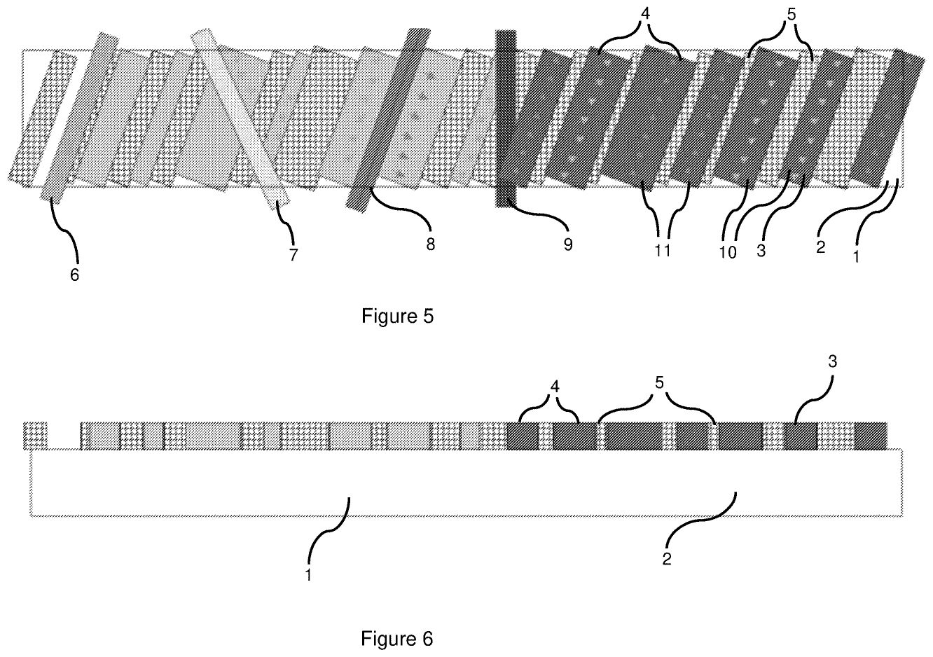

FIG. 5 shows a plan view of the creation of a set of magnetic security features;

FIG. 6 shows a side view of the creation of the set of magnetic security features of FIG. 5;

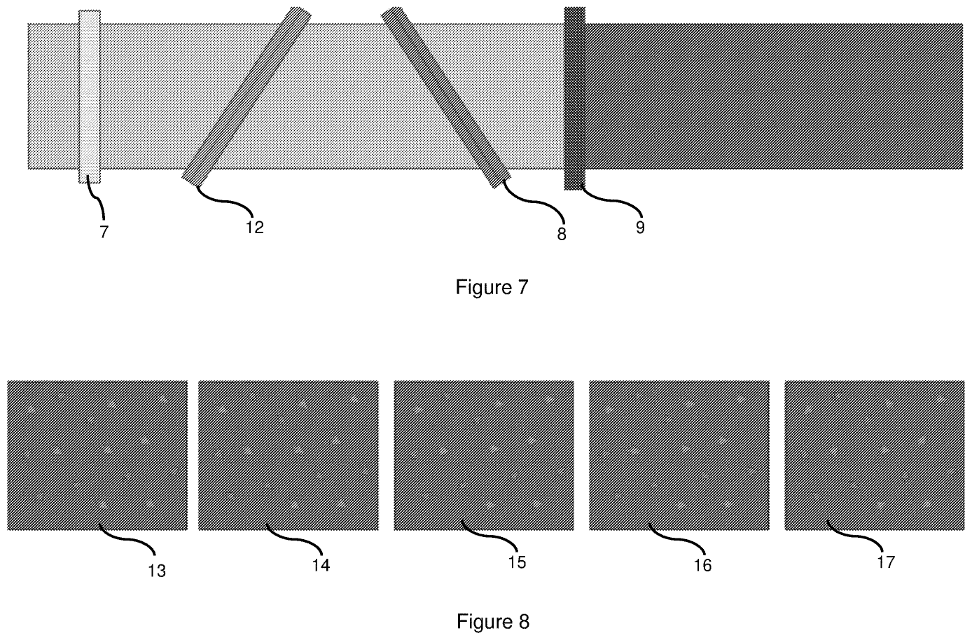

FIG. 7 shows a plan view of the creation of a set of magnetic security features; and

FIG. 8 shows five different regions generated in the set of magnetic security features of FIG. 7.

The set of magnetic security features 1 shown in the figures is a set of security threads each with a magnetic element, although in other embodiments it can be any suitable magnetic security feature. The set is a panel which, once the magnetic elements are created thereon, will be cut along its length into separate, identical magnetic security features. The set 1 means a plurality of magnetic security features can be created at the same time. Each magnetic security feature comprises a substrate 2 and a printed ink layer 3. The substrate 2 is rectangular. The ink comprises a set of particles, the set of particles being held in suspension in the liquid ink prior to curing. The particles are magnetically anisotropic and are acicular.

In the embodiment shown in FIGS. 1 and 2, the surface of the substrate 2 is a pattern of ridges 5 and voids, the voids forming a series of wells 4 between the ridges 5. Each ridge 5 and each well 4 is rectangular and extends across the entire width of the substrate 2. The ridges 5 and wells 4 are a variety of different lengths along the length of the substrate 2. In other embodiments, the ridges 5 (and/or the wells 4) can all have an equal length or they can split into one or more sets, the ridges 5 (and/or wells 4) in each set having an equal length but each set having a different length.

The pattern is formed in the substrate via any suitable method, including gravure printing, chemical etching, or laser ablation. The substrate 2 is then passed through a magnetic security feature manufacturing machine. The substrate travels in the direction of its longitudinal axis.

The magnetic security feature manufacturing machine comprises a printer 6, a first magnet 7, a second magnet 8 and an ultra-violet light source 9. The first magnet 7 is a permanent magnet, while the second magnet 8 is an electromagnet. The printer 6, first magnet 7, second magnet 8, and ultra-violet light source 9 are positioned in a line along the magnetic security feature manufacturing machine, from the entrance to the exit. The first magnet 7 and second magnet 8 are spaced apart from each other enough such that their magnetic fields don't interfere with each other or with the areas of the magnetic security feature 1 they are magnetising at a point in time. The printer 6, first magnet 7, second magnet 8 and ultra-violet light source 9 extend far enough such that, in use, they extend across the entire width of the substrate 2.

The first end of the substrate 2 enters the magnetic security feature manufacturing machine, and the printer 6 begins to print along the length starting from the first end as the substrate 2 moves. In the embodiment shown in FIGS. 1 and 2, the printer is positioned to be across the substrate 2, orthogonally to the longitudinal axis. The minimum length feature which the printer 6 can print is the same length or shorter than the shortest length of well 4. The printer 6 is moved by the magnetic security feature manufacturing machine into contact with the substrate, although in alternative embodiments it can be positioned such that it starts in contact with the substrate 2. As it prints along the length of the substrate 2 due to the movement of the substrate 2, the printer 6 prints ink into the wells 4 to form the printed ink layer 3. The ink fills each well 4 entirely, ending up nearly level with the tops of the ridges 5. As the substrate 2 passes through, the printer 6 fills more and more of the wells 4.

In other embodiments the printer 6 may form such a non-contiguous layer of printed ink 3 on a substrate 2 with a flat (i.e. non-patterned) surface. It these embodiments the printer 6 prints only on selected areas of the substrate 2, being directed by its controller. The remaining areas are left empty, to form the separation between units.

As the substrate 2 moves further through the magnetic security feature manufacturing machine, it begins to pass over the first magnet 7. The first magnet 7 is positioned adjacent to the substrate 2 and underneath it, such that it can magnetise the areas above it. In other embodiments the first magnet 7 (and the second magnet 8) can be in other positions around the area of the printed ink layer 3, so long as the field lines sufficiently penetrate the area to magnetise the particles within while not penetrating other areas of the printed ink layer 3 to magnetise the particles within them. The first magnet 7 is positioned at an angle to the orthogonal to the longitudinal axis, such that particles are orientated in a direction which is between 30 to 60 degrees the longitudinal axis of the substrate 2. In other embodiments the first magnet 7 can be positioned at a variety of different angles, so long as it differs from the angle of the second magnet 8. The first magnet 7, being a permanent magnet, magnetises the particles in the whole printed ink layer 3. The magnetic field strength of the first magnet 7 is greater than the coercivity of the first and of the second set of particles, so that all the particles are re-orientated in its field.

In other embodiments the first magnet 7 may be an electromagnet or otherwise only be exposed to part of the printed ink layer 3 to magnetise that part and leave the rest unmagnetized.

As the substrate 2 moves past the first magnet 7 it encounters the second magnet 8. The second magnet 8 is positioned to extend across the substrate 2 but underneath it, orthogonally to the longitudinal axis, and such that, in the embodiment shown in FIGS. 1 and 2, those particles reorientated within its field are orientated along a direction parallel to the longitudinal axis. The second magnet 8 also has a magnetic field strength higher than the coercivity of the particles, such that it can reorientate those in the area underneath it.

The second magnet 8 is pulsed on and off in a pattern as it passes over the substrate 2, dictated by its controller. In alternative embodiments the current through it can vary in both magnitude and direction. When on, it re-orientates the particles in the sections of ink underneath it. When off, the other parts of the ink underneath do not have their particles re-orientated. This resulted in the printed ink layer 3 being formed from units of ink 10, 11, each unit having its particles orientated in a different direction to its adjacent units and/or separated via a ridge from its adjacent units. There is a first set of units of ink 10, wherein the particles are orientated in the first direction matching the field of the first magnet 7, and a second set of units of ink 11, wherein the particles are orientated in the second direction matching the field of the second magnet 8. The units 10, 11 vary in length along the length of the substrate 2, although in other embodiments units 10, 11 in a set can all be equal length. Some units 10, 11 are discrete (i.e. have spaces in the printed ink layer, due to ridges 5, to either side) while some are semi-discrete (i.e. have a space in the printed ink layer to one side but are contiguous with the adjacent unit on the other side). In other embodiments some units can also be fully contiguous with adjacent units, or can contain a different mixture of discrete, semi-discrete and/or contiguous (or even all the units 10, 11 can be one type).

The second magnet 8 is rectangular and due to its angle the resulting units 10, 11 are rectangular as well. FIGS. 5 and 6 show an alternative embodiment in which the second magnet 8 is at an angle and therefore each unit is substantially a rhomboid, except for the first and last units given they include the corners of the rectangular substrate 2.

As the substrate 2 moves further through the machine it falls underneath the ultra-violet light source 9. The ultra-violet light source 9 directs light onto the area of the substrate 2 it faces, which cures the particular area of the printed ink layer 3. As such, as the substrate passes through the ultra-violet light source 9 cures along the length of the substrate 2 the printed ink layer 3 is cured, fixing the particles within the ink in their orientations.

While the second magnet 8 can, in other embodiments, be positioned at a variety of different angles, the angle either needs to match the angle of the units of ink to be formed or be chosen such that the second magnet 8 does not extend across a section to be magnetised and another part of the printed ink layer 3 at the same time (being limited by the space between adjacent units of different magnetisations, for example).

When the substrate 2 begins passing under the ultra-violet light source 9, part of the substrate 2 further along the length is still underneath the printer 6. As such, for a period of time the printer 6, first magnet 7, second magnet 8 and ultra-violet light source 9 are all acting on the magnetic security feature 1.

The magnetic security feature 1 then comes out of the magnetic security feature manufacturing machine with the particles orientated in a pattern of units 10, 11 of the first direction and the second direction, and a pattern of units of varying sizes, the patterns being locked in by curing. Information is encoded in the patterns of first direction and second direction and lengths, which can be read by a machine. The information encoded can relate to a document the magnetic security feature 1 is to be applied to, or otherwise verify the document, as desired by a user. For example, the information may indicate currency or denomination of a banknote, or perhaps a unique code for a credit or debit card. Once the magnetic security feature 1 is finished it is applied to a document in the desired way, for example being embedded into the document.

The embodiment of FIGS. 3 and 4 is similar to the embodiment of FIGS. 1 and 2. The printed ink layer 3 is contiguous though, the surface of the substrate 2 being level and the printer 6 (not shown in FIGS. 3 and 4, printing having being finished by this point in the process) continuously printing ink onto the surface to cover it entirely. In addition, the ink comprises two sets of particles, the first set having a higher coercivity than the second set.

Further to this, the first magnet 7 has a magnetic field strength greater than the coercivity first set of particles, and so reorientates both sets of particles. However, the second magnet 8 has a magnetic field strength which is higher than the coercivity of the second set of particles but lower than the coercivity of the first set of particles. As such, the second magnet 8 only reorientates the second set of particles even when it is on, the first set of particles remaining unchanged. The resulting printed ink layer 3 is formed of units of a first set 10 in which all the particles are orientated in a first direction and units of a second set 11 in which the first set of particles are orientated in the first direction and the second set of particles are orientated in a second direction.

The first magnet 7 is orientated at an angle to the orthogonal to the longitudinal axis, the first direction being 30-90 degrees to the longitudinal anti-clockwise when the second end is on the left. The second magnet is also 30-90 degrees to the orthogonal to the longitudinal axis, but clockwise when the second end is on the left.

Finally, the first set of units 10 and the second set of units 11 are each respectively the same length, and rather than being rectangular are substantially rhomboids except for the first and last units, given they include the corners of the rectangular substrate 2.

The information in the resulting magnetic security feature 1 is encoded in the size of the units of each set and the resulting pattern they form.

Embodiments more similar to that of FIGS. 1 and 2 can also have ink comprising a first and a second set of particles, and a second magnet 8 with a magnetic field strength which is greater than the coercivity of the particles of the second set but lower than the coercivity of the particles of the first set. This results in both the first and second units 10, 11 having the first set of particles orientated in the first direction, and differing via the second set of particles being orientated in either the first direction (in the first set of units 10) or the second direction (on the second set of units 11).

On top of this, in other embodiments the first magnet 7 can be an electromagnet or otherwise only magnetise part of the printed ink layer 3. This results in two different patterns of magnetisation across the printed ink layer 3, of unoriented particles of the first set versus particles of the first set orientated in the first direction and unoriented particles of the second set, particles of the second set orientated in a first direction and particles of the second set orientated in a second direction, allowing for a variety of units of ink with different magnetisation readings and so more information to be encoded within the pattern.

FIG. 7 shows a method similar to the method of FIG. 3, but additionally involving a third magnet 12 and wherein the first magnet 7 is an electromagnet. The first magnet 7 is positioned to have a width which is parallel to the width of the set of magnetic security threads and, as the magnetic security threads pass underneath it, is pulsed on and off, orientating the first and second particles in some sections but not others. The set of magnetic security threads then passes under the third magnet 12 after passing under the first magnet 7. The third magnet 12 is an electromagnet as well, which has a magnetic field strength greater than the coercivity first set of particles, and so reorientates both sets of particles as well. The third magnet 12 is positioned such that its width is at an angle to the width of the set of magnetic security threads. The third magnet 12 is also pulsed on and off. The pulsing of the third magnet 12 varies from the pulsing of the first magnet 7, and in this embodiment varies such that it reorientates the particles in some sections in which the particles were orientated by the first magnet and orientates the particles in some sections were the first magnet 7 was off. In other embodiments, the pulsing of the third magnet 12 may be the opposite of the first magnet 7, such that it orientates the particles in sections were the first magnet 7 was off and is off when sections orientated by the first magnet 7 are underneath.

The set of magnetic security threads then pass underneath the second magnet 8, which in this embodiment is orientated at an angle to the width of the set of magnetic security threads which is different from the angle of the third magnet 12 and also different from the angle of the first magnet 7. In other embodiments it may be orientated at the same angle as either the first magnet 7 or the third magnet 12. As in the method of FIG. 3, the magnetic field strength of the second magnet 8 is high enough to reorientate the second set of particles but not the first set of particles. The second magnet 8 is also an electromagnet, and pulses on and off to reorientate the particles of the second set in some sections.

The end result is a set of magnetic security threads with sections, each section falling into one of five regions (shown in FIG. 8). In a first region 13 the particles of the first set are orientated by the third magnet 12 and the particles of the second set are orientated by the second magnet 8. In the second region 14 the particles of both the first and second sets are orientated by the third magnet 12. In the third region 15 the particles of the first set are orientated by the first magnet 7 and the particles of the second set are orientated by the second magnet 8. In the fourth region 16 particles of both the first and second sets are orientated by the first magnet 7. Finally, in the fifth region 17 the particles of both sets are unorientated.

In an alternative embodiment, the third magnet 12 may be removed and instead the write current though the second magnet 8 may be varied, such that at times it is strong enough to orientate (or reorientate) particles of both sets and at other times it can only reorientate particles of the second set.

In other embodiments the method of FIG. 7 can be applied to a non-contiguous set of magnetic security threads.

The one or more embodiments are described above by way of example only. Many variations are possible without departing from the scope of protection afforded by the appended claims.

1. A method of creating a magnetic security feature, the method comprising the steps of:
(a) printing an ink onto a substrate, the ink comprising a first set of particles and a second set of particles, wherein the particles are magnetically anisotropic and the coercivity of the particles of the first set is higher than the coercivity of the particles of the second set;
(b) exposing at least part of the printed ink layer to a first magnet with a magnetic field strength greater than the coercivity of the particles of the first set and aligned in a first direction, to orientate the particles of the first set and the second set in a first direction;
(c) exposing one or more sections of the printed ink layer to a second magnet with a magnetic field strength greater than the coercivity of the particles of the second set but less than the coercivity of the particles of the first set and aligned in a second direction, to orientate the particles of the second set in the sections of the security thread in a second direction, the second direction being different from the first direction; and then
(d) curing the printed ink layer so that the particles of the first and second sets are locked in their orientations.

2. The method according to claim 1, wherein the particles of the first and/or second set are non-spherical.

3. The method according to claim 2, wherein the particles of the first and/or second set are acicular.

4. The method according to claim 1, wherein the printed ink layer is one or more units of ink.

5. The method according to claim 4, wherein the one or more of the units of ink are discrete.

6. The method according to claim 1, wherein the first magnet is a permanent magnet.

7. The method according to claim 1, wherein the second magnet is an electromagnet.

8. The method according to claim 7, wherein the electromagnet is pulsed on and off.

9. The method according to claim 7, wherein a current through the electromagnet is varied in magnitude.

10. The method according to claim 7, wherein a current through the electromagnet is varied in direction.

11. The method according to claim 1, wherein the ink is ultra-violet light curable.

12. The method according to claim 11, comprising exposing the printed ink layer to an ultra-violet light source to cure the ink.

13. The method according to claim 1, wherein the second direction is between 20 and 90 degrees to the first direction.

14. The method according to claim 1, wherein the second direction is between 20 and 60 degrees to the first direction.

15. The method according to claim 1, wherein the first direction is at an angle to a longitudinal axis of the printed ink layer.

16. The method according to claim 1, wherein the second direction is in line with the longitudinal axis of the printed ink layer.

17. The method according to claim 4, wherein the second direction is in line with a length of each unit of the printed ink layer.

18. The method according to claim 1, wherein step (c) is subsequent to step (b).

19. The method according to claim 1, wherein a printer prints along a length of the substrate to print the layer of ink.

20. The method according to claim 1, wherein the magnetic security feature is a security thread with a magnetic element.

21. The method according to claim 1, wherein the substrate is a filament.

22. A magnetic security feature comprising a substrate and a printed ink layer, wherein:
(a) the printed ink layer is on the substrate;
(b) the ink comprises a first set of particles and a second set of particles, wherein the particles in the first set and in the second set are magnetically anisotropic and the coercivity of the particles of the first set being higher than the coercivity of the particles of the second set;
(c) within at least part of the printed ink layer, wherein the particles of the first set of particles are orientated in a first direction;
(d) within one or more sections of the printed ink layer, wherein the particles of the second set of particles are orientated in a second direction, wherein the second direction is different from the first direction; and
(e) the printed ink layer is cured.

23. A method of creating a magnetic security feature, the method comprising the steps of:
(a) printing an ink onto a substrate to form a non-contiguous layer of printed ink, the ink comprising a set of particles, wherein the magnetic particles within the set of magnetic particles are magnetically anisotropic;
(b) exposing at least part of the non-contiguous layer of printed ink to a first magnet with a magnetic field strength greater than the coercivity of the particles and aligned in a first direction, to orientate the particles in a first direction;
(c) exposing one or more sections of the non-contiguous layer of printed ink to a second magnet with a magnetic field strength greater than the coercivity of the particles and aligned in a section direction, to orientate the particles in a second direction, the second direction being different from the first direction; and
(d) curing the printed ink, locking the particles in their orientations.

24. A magnetic security feature comprising a printed ink layer and a substrate, wherein:
(a) the printed ink layer is non-contiguous;
(b) the ink comprises a set of magnetic particles, wherein the magnetic particles within the set of magnetic particles are magnetically anisotropic;
(c) within at least part of the non-contiguous printed ink layer, the magnetic particles are orientated in a first direction;
(d) within one or more sections of the non-contiguous printed ink layer, the magnetic particles are orientated in a second direction which is different from the first direction; and
(e) the ink is cured.

25. A document comprising a magnetic security feature according to claim 22.
